(19) United States
(12) Patent Application Publication
(10) Pub. No.: US 2024/0109360 A1
(43) Pub. Date: Apr. 4, 2024

(54) METHOD FOR MANUFACTURING PRINTED MATERIAL, PRINTED MATERIAL, AND THERMAL TRANSFER SHEET

(71) Applicant: DAI NIPPON PRINTING CO., LTD., Tokyo (JP)

(72) Inventors: Ryoji HATTORI, Tokyo (JP); Takashi ITO, Tokyo (JP); Akihiro TADA, Tokyo (JP)

(73) Assignee: DAI NIPPON PRINTING CO., LTD., Tokyo (JP)

(21) Appl. No.: 18/258,843

(22) PCT Filed: Jan. 17, 2022
(86) PCT No.: PCT/JP2022/001399

§ 371 Date: Jun. 22, 2023

(30) Foreign Application Priority Data
Jan. 18, 2021 (JP) 2021-005867

(51) Int. Cl. B41M 5/40; B41M 5/382

(52) U.S. Cl. CPC B41M 5/40; B41M 5/382

(57) ABSTRACT

The present disclosure provides a printed material having a high-definition uneven pattern including expanded portions and a method for manufacturing the printed material. A method for manufacturing a printed material includes a step of preparing a thermal transfer sheet including a substrate and a transfer layer that is disposed on one surface side of the substrate and includes a layer containing foamable particles, and a step of heating the thermal transfer sheet to transfer the transfer layer of the thermal transfer sheet in a prescribed pattern a plurality of times onto a transfer receiving body to thereby form a layered body including a plurality of the transfer layers stacked one on another.

### TECHNICAL FIELD

The present disclosure relates to a method for manufacturing printed material, a printed material, and a thermal transfer sheet.

### BACKGROUND ART

Various thermal transfer methods using dyes or pigments have been proposed. Printed materials manufactured by the thermal transfer methods find a wide range of applications and are being used, for example, for photo cards such as ID cards and credit cards, composite photographs in amusement parks, and trading cards.

In recent years, printed materials having a simple three-dimensional uneven shape including expanded portions formed by heating a card containing foamable particles in a given pattern are increasingly used. However, one problem with a pattern such as letters and images formed by expanding foamable particles is that the pattern may be collapsed and difficult to recognize visually.
PTL 1: JP 5-254238 A

### SUMMARY OF INVENTION

It is an object of the present disclosure to provide a printed material having a high-definition uneven pattern including expanded portions and to provide a method for manufacturing the printed material. It is another object of the disclosure to provide a thermal transfer sheet used to manufacture a printed material having a high-definition uneven pattern including expanded portions.

According to the present disclosure, a method for manufacturing a printed material includes a step of preparing a thermal transfer sheet including a substrate and a transfer layer that is disposed on one surface side of the substrate and includes a layer containing foamable particles, and a step of heating the thermal transfer sheet to transfer the transfer layer of the thermal transfer sheet in a prescribed pattern a plurality of times onto a transfer receiving body to thereby form a layered body including a plurality of the transfer layers stacked one on another.

According to the present disclosure, a printed material includes a transfer receiving body, an a layered body disposed on the transfer receiving body and including a plurality of transfer layers stacked one on another. Each of the plurality of transfer layers includes an adhesive layer and a layer containing foamable particles that are stacked in this order from a side toward the transfer receiving body.

According to the present disclosure, a thermal transfer sheet includes a substrate, and a plurality of transfer layers disposed on one surface of the substrate in a frame sequential manner. Each of the plurality of transfer layers includes a layer containing foamable particles and an adhesive layer that are stacked in this order on one surface side of the substrate.

### Advantageous Effects of Invention

According to the present disclosure, a printed material having a high-definition uneven pattern including expanded portions can be manufactured.

### BRIEF DESCRIPTION OF DRAWINGS

FIG. 1 A cross-sectional view of a thermal transfer sheet in an embodiment.

FIG. 2 A process cross-sectional view illustrating a printed material manufacturing method.

FIG. 3 A process cross-sectional view illustrating a printed material manufacturing method.

FIG. 4 A process cross-sectional view illustrating a printed material manufacturing method.

FIG. 5a A process cross-sectional view illustrating a printed material manufacturing method in a comparative example.

FIG. 5b A process cross-sectional view illustrating a printed material manufacturing method in a comparative example.

FIG. 6 A process cross-sectional view illustrating a printed material manufacturing method in another embodiment.

FIG. 7 A plan view of a thermal transfer sheet.

FIG. 8a A process cross-sectional view illustrating a printed material manufacturing method in another embodiment.

FIG. 8b A process cross-sectional view illustrating a printed material manufacturing method in another embodiment.

FIG. 9a A process cross-sectional view illustrating a printed material manufacturing method in another embodiment.

FIG. 9b A process cross-sectional view illustrating a printed material manufacturing method in another embodiment.

FIG. 10 A process cross-sectional view illustrating a printed material manufacturing method in another embodiment.

FIG. 11 A top view of a printed material in an embodiment.

FIG. 12 A top view of a printed material in a comparative example.

### DESCRIPTION OF EMBODIMENTS

Embodiments of the present disclosure will next be described based on the drawings. In the drawings, the width, thickness, etc. of each component illustrated may be more schematic than the actual width, thickness, etc., for the purpose of clearer illustration, but these drawings are merely illustrative and do not limit the interpretation of the disclosure. In the present description and the drawings, the same components as those previously described will be denoted by the same numerals, and their description will be omitted.

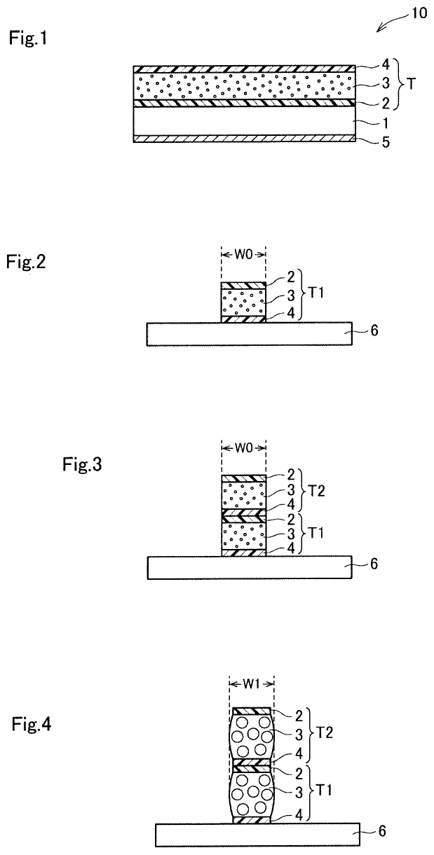

FIG. 1 is a cross-sectional view of a thermal transfer sheet in an embodiment of the present invention. As shown in FIG. 1, the thermal transfer sheet 10 includes a transfer layer T disposed on one surface of a substrate 1 and a back layer 5 disposed on the other surface. The transfer layer T includes a peeling layer 2, a foaming layer 3, and an adhesive layer 4 that are stacked in this order from the substrate 1 side. The foaming layer 3 is a foamable particle-containing layer containing unformed foamable particles. The foamable particles each include an outer shell formed of a thermoplastic resin and a foaming agent enclosed in the outer shell and to be vaporized upon heating. Therefore, the foamable particles are expanded upon heating. The glass transition temperature of a first resin in the peeling layer 2 and the glass transition temperature of a first resin in the adhesive layer 4 are higher than the glass transition temperature of a first binder resin in the foaming layer 3. Each first resin is a resin with the highest mixing ratio among the resins contained in the peeling layer 2 or the adhesive layer 4. The first binder resin is a resin with the highest mixing ratio among the binder resins contained in the foaming layer 3.

When a printed material is manufactured, a well-known thermal transfer printer including a thermal head is used to laminate the thermal transfer sheet 10 and a transfer receiving body 6 (see FIG. 2) together such that the adhesive layer 4 of the thermal transfer sheet 10 and the transfer receiving body 6 face each other. Then the thermal transfer sheet 10 is heated in a prescribed pattern from the back layer 5 side to transfer a first transfer layer T(T1) onto the transfer receiving body 6. The transfer layer T transferred from the thermal transfer sheet 10 onto the transfer receiving body 6 includes the adhesive layer 4, the foaming layer 3, and the peeling layer 2, and the peeling layer 2 does not remain on the substrate 1 of the thermal transfer sheet 10. In this case, the thermal energy applied to the thermal transfer sheet 10 is such that the transferred foaming layer 3 does not expand in the plane directions. The transferred pattern includes linear or curved line portions having a line width W0.

No particular limitation is imposed on the transfer receiving body 6, and the transfer receiving body 6 is, for example, a plastic card substrate or paper. The transfer receiving body 6 may have a flat shape or a curved shape.

Next, the same thermal transfer sheet 10 as above or a different thermal transfer sheet 10 and the transfer receiving body 6 with the transfer layer T1 transferred thereonto are laminated together, and the thermal transfer sheet 10 is heated in the same pattern as above from the back layer 5 side. As shown in FIG. 3, a second transfer layer T(T2) is thereby transferred onto the first transfer layer T1, and a layered body including the transfer layers T1 and T2 stacked together is thereby formed.

Next an image (not shown) is formed on the transfer receiving body 6 having the layered body including the transfer layers T1 and T2. No particular limitation is imposed on the image formation method, and a sublimation transfer method, a melt transfer method, an inkjet method, etc. may be used. When the sublimation transfer method or the inkjet method is used, it is preferable that a receiving layer is transferred onto the transfer receiving body 6 so as to cover the transfer layers T1 and T2 and then a coloring material is transferred to form an image. After the formation of the image, a protective layer may be transferred. An intermediate transfer medium may be used to transfer a layer having an image formed thereon onto the transfer receiving body 6 having the layered body disposed thereon.

After the formation of the image, a heating device such as a heating roller, an oven, or a thermal head is used to heat the transfer receiving body 6. As a result of the heating, the foamable particles in the foaming layers 3 of the transfer layers T1 and T2 are expanded as shown in FIGS. 4 and 11. The expansion of the foamable particles causes the foaming layers 3 to expand not only in the vertical direction (the height direction) but also in the horizontal directions. The larger the thickness (volume) of the foaming layers 3, the larger the amount of expansion in the horizontal directions. However, in the present embodiment, since the two foaming layers 3 are separated from each other with high-glass transition temperature resin layers (a peeling layer 2/a n adhesive layer 4) interposed therebetween, the thickness (volume) per layer can be reduced, and the amount of expansion in the horizontal directions, i.e., the line width W1 after the expansion, can be reduced.

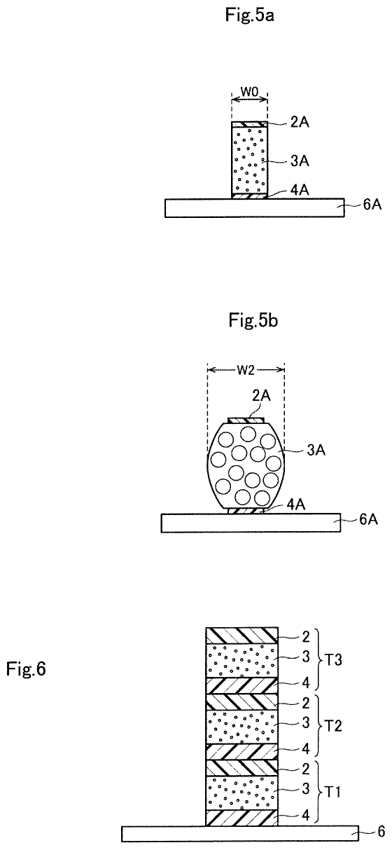

FIGS. 5a and 5b show a printed material manufacturing method in a comparative example. As shown in FIG. 5a, a transfer layer including an adhesive layer 4A, a foaming layer 3A, and a peeling layer 2A stacked together is transferred in a line pattern having a line width W0 onto a transfer receiving body 6A. The thickness of the foaming layer 3A is about twice the thickness of each of the foaming layers 3 described above.

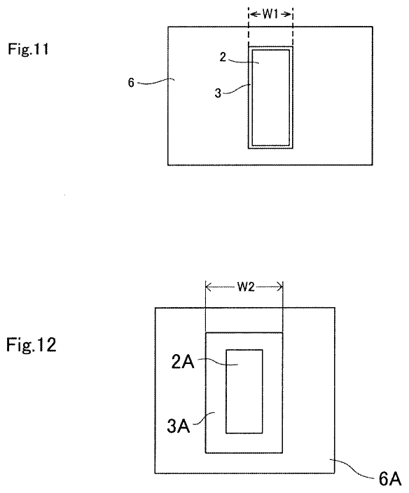

After the transfer of the transfer layer, the transfer receiving body 6A is heated, and the foamable particles in the foaming layer 3A are thereby expanded as shown in FIGS. 5b and 12. The expansion of the foamable particles causes the foaming layer 3A to expand also in the horizontal directions. The thickness (volume) per layer of the foaming layer 3A is larger than that of the foaming layers 3 described above, and, in particular, the amount of expansion in the thicknesswise central portion in the horizontal directions is large. The line width W2 after the expansion is larger than the line width W1 in FIGS. 4 and 11, and it is therefore difficult to express a high-definition uneven pattern.

However, in the present embodiment, the transfer layer T is transferred twice, and the two foaming layers 3 are spaced apart with the high-glass transition temperature resin layers (a peeling layer 2 and/or an adhesive layer 4) interposed therebetween. In this manner, the thickness (volume) per foaming layer is reduced, and the amount of expansion in the horizontal directions is reduced, so that a high-definition uneven pattern (concave-convex pattern) can be expressed.

In the description of the above embodiment, the transfer layer T is transferred twice to stack the two transfer layers T1 and T2. However, the number of times the transfer layer T is transferred may be three or more. FIG. 6 shows a structure in which the transfer layer T is transferred three times to stack three transfer layers T1 to T3.

The transfer of the transfer layer T and the image formation may be performed using the same printer or different printers. When the same printer is used, the thermal transfer sheet for transferring the transfer layer T and the thermal transfer sheet for transferring the coloring material may be an integrated sheet or may be different sheets. One thermal transfer sheet in which transfer layers including respective foamable particle-containing layers having different thicknesses are disposed in a frame sequential manner may be used.

When separate thermal transfer sheets are used, for example, a first thermal transfer sheet for transferring the transfer layer T, a second thermal transfer sheet for transferring the coloring material, and a third thermal transfer sheet for transferring the receiving layer are prepared. The first thermal transfer sheet includes a first substrate on which the transfer layer T is disposed. The second thermal transfer sheet includes a second substrate on which the coloring material layer is disposed. The third thermal transfer sheet includes a third substrate on which the receiving layer is disposed.

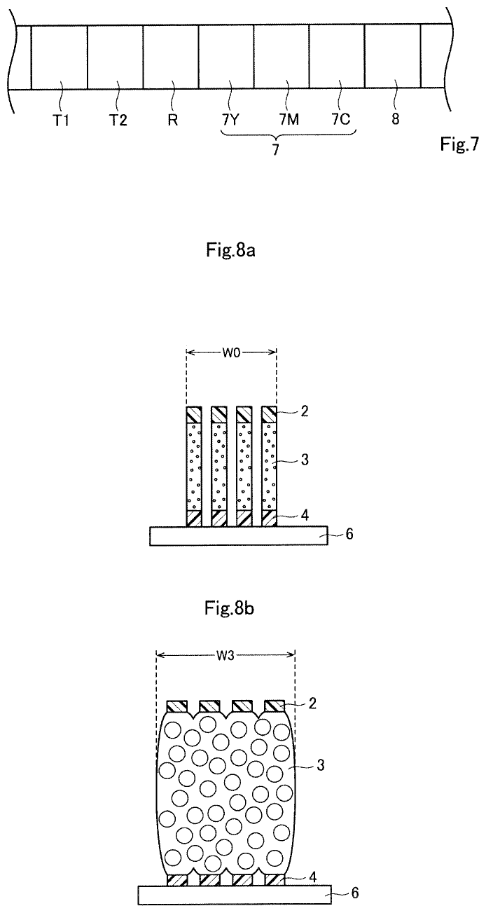

FIG. 7 is a plan view of a thermal transfer sheet in which a thermal transfer sheet for transferring transfer layers T and a thermal transfer sheet for transferring coloring materials are integrated (into a single ribbon). This thermal transfer sheet includes transfer layers T1 and T2, a transfer-type receiving layer R, a coloring material layer 7, and a protective layer 8 that are disposed in a frame sequential manner on one surface of a substrate.

The coloring material layer 7 includes a yellow coloring material layer 7Y containing a yellow coloring material, a magenta coloring material layer 7M containing a magenta coloring material, and a cyan coloring material layer 7C containing a cyan coloring material that are disposed in a frame sequential manner. The coloring materials contained in the yellow coloring material layer 7Y, the magenta coloring material layer 7M, and the cyan coloring material layer 7C are, for example, sublimation dyes.

When the thermal transfer sheet shown in FIG. 7 is used, first, the transfer layers T1 and T2 are sequentially heated in the same pattern to transfer and stack the transfer layers T1 and T2 onto a transfer receiving body. Then the transfer-type receiving layer R is transferred onto the transfer receiving body. Next, the yellow coloring material layer 7Y, the magenta coloring material layer 7M, and the cyan coloring material layer 7C are sequentially transferred to form an image on the receiving layer R on the transfer receiving body. Then the protective layer 8 is heated to transfer the protective layer 8 onto the receiving layer R with the image formed thereon.

When the coloring materials contained in the coloring material layer 7 are thermo-fusible inks, the transfer-type receiving layer R can be omitted.

In the description of the structure of the above embodiment, the transfer layers T (foaming layers 3) are stacked so that the thickness (volume) per foaming layer 3 is reduced, and the amount of expansion in the horizontal directions is thereby reduced. However, as shown in FIG. 8a, a transfer layer T may be transferred not into a solid pattern but into a dot pattern to reduce the horizontal width of the foaming layers 3. The distance between the transfer layers T at opposite edges is defined as W0.

Heating treatment is performed to expand the foamable particles in the foaming layers 3. Then the foaming layers 3 in adjacent dot-shaped transfer layers T are joined together to form a line portion having a line width W3, as shown in FIG. 8b. Since the transfer layers T are transferred in the dot pattern, the volume of each foaming layer 3 is small, and the amount of expansion in the horizontal directions is reduced. In this case, the line width W3 is only slightly larger than W0, and a high-definition uneven pattern can be expressed.

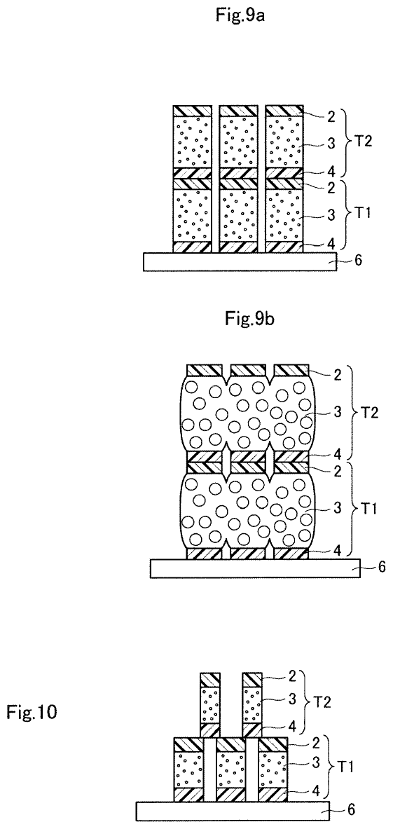

As shown in FIG. 9a, transfer layers T (T1 and T2) may be transferred into a two-layer dot pattern. When heating treatment is performed, the foaming layers 3 in adjacent dot-shaped transfer layers T1 are joined together, and the foaming layers 3 in adjacent dot-shaped transfer layers T2 are also joined together, as shown in FIG. 9b. In this manner, a higher-definition uneven pattern can be expressed.

As shown in FIG. 10, the dot pattern of first transfer layers T1 and the dot pattern of second transfer layers T2 may be displaced from each other, or they may have different sizes (widths).

In the above embodiment, the foamable particles are expanded after the formation of the image, but the image may be formed after the expansion of the foamable particles.

The receiving layer with the image formed thereon may be transferred onto the transfer receiving body 6, and then the transfer layers T1 and T2 may be transferred onto the transfer receiving body 6 (receiving layer) to form a layered body.

In the description of the structure of the above embodiment, the transfer layer T including the peeling layer 2, the foaming layer 3, and the adhesive layer 4 stacked in this order is disposed on one surface of the substrate 1 of the thermal transfer sheet 10. However, a release layer may be disposed between the substrate 1 and the transfer layer T.

Specifically, the release layer, the peeling layer, the foaming layer, and the adhesive layer may be stacked in this order on one surface of the substrate 1 of the thermal transfer sheet 10. Alternatively, the peeling layer may be omitted from the transfer layer T, and the release layer, the foaming layer, and the adhesive layer may be stacked in this order on one surface of the substrate 1 of the thermal transfer sheet 10. After the transfer of the transfer layer T onto the transfer receiving body 6, the release layer remains on the substrate 1.

Next, the structural components of the thermal transfer sheet 10 will be described.

### (Substrate)

No particular limitation is imposed on the substrate 1 of the thermal transfer sheet 10, and any substrate known in the field of thermal transfer sheets may be appropriately selected and used. Examples of the substrate include stretched and unstretched films of plastics such as polyester, polyphenylene sulfide, polyether ketone, polyethersulfone, polypropylene, polycarbonate, cellulose acetate, polyethylene derivatives, polyvinyl chloride, polyvinylidene chloride, polystyrene, polyamide, polyimide, polymethylpentene, and ionomers. Highly heat resistant polyester is preferred, and examples thereof include polyethylene terephthalate, polyethylene naphthalate, and polybutylene terephthalate. A composite film prepared by stacking two or more of these materials may also be used. No particular limitation is imposed on the thickness of the substrate 1, but the thickness is preferably in the range of from 2 μm to 10 μm inclusive.

### (Peeling Layer)

To improve the transferability of the transfer layer T, the peeling layer 2 is disposed in the transfer layer T at a position closest to the substrate 1. Examples of a binder resin included in the peeling layer include: cellulose derivatives such as ethyl cellulose, nitrocellulose, and cellulose acetate; acrylic resins such as polymethyl methacrylate, polyethyl methacrylate, and polybutyl acrylate; thermoplastic resins exemplified by vinyl resins such as polyvinyl chloride, vinyl chloride-vinyl acetate copolymers, and polyvinyl butyral; thermosetting resins exemplified by saturated and unsaturated polyesters, polyurethane resins, thermosetting epoxy-amino copolymers, and thermosetting alkyd-amino copolymers (thermosetting aminoalkyd resins); silicone wax; silicone resins; silicone-modified resins; fluorine resins; fluorine-modified resins; and polyvinyl alcohol.

Preferably, the glass transition temperature (Tg) of the first resin in the peeling layer is higher than the glass transition temperature of the first binder resin in the foaming layer described later. When the glass transition temperature of the first resin in the peeling layer is high, the foaming agent is prevented from breaking through the foaming layer (first binder resin) during heating of the foaming layer, and the peeling layer serves as a cover. In the present disclosure, Tg is a value determined by differential scanning calorimetry (DSC) according to JIS K 7121.

### (Foaming Layer)

The foaming layer 3 contains the foamable particles and the binder resin. The foamable particles are thermally expandable microspheres each including an outer shell (shell) formed of a thermoplastic resin and a foaming agent (core) enclosed in the shell. The foamable particles have a core-shell structure, and the microspheres as a whole exhibit thermal expandability (the property of expanding upon heating). The thermoplastic resin is a polymer of a polymerizable component.

The polymerizable component means a monomer having at least one polymerizable group in its molecule and is a component that is polymerized to form the thermoplastic resin forming the outer shell of each foamable particle. Examples of the polymerizable component include non-crosslinkable monomers having one reactive carbon-carbon double bond (which are hereinafter referred to simply as non-crosslinkable monomers) and crosslinkable monomers having two or more reactive carbon-carbon double bonds (which are hereinafter referred to simply as crosslinkable monomers). A crosslinkable monomer allows a crosslinking structure to be introduced into a polymer. The reactive carbon-carbon double bond as used herein means a carbon-carbon double bond having radical reactivity and is not carbon-carbon double bonds in aromatic rings such as benzene rings and naphthalene rings, and examples thereof include carbon-carbon double bonds included in a vinyl group, a (meth)acryloyl group, an allyl group, a vinylene group, etc. The (meth)acryloyl group is meant to encompass an acryloyl group and a methacryloyl group.

The foaming agent is a component that is vaporized upon heating. No particular limitation is imposed on the foaming agent. Examples of the foaming agent include: hydrocarbons having 3 to 13 carbon atoms such as propane, (iso)butane, (iso)pentane, (iso)hexane, (iso)heptane, (iso)octane, (iso)nonane, (iso)decane, (iso)undecane, (iso)dodecane, and (iso)tridecane; hydrocarbons having more than 13 and 20 or less carbon atoms such as (iso)hexadecane and (iso)eicosane; hydrocarbons from petroleum fractions such as pseudocumene, petroleum ether, and normal paraffins and isoparaffins having an initial boiling point of from 150° C. to 260° C. inclusive and/or distilled at a temperature in the range of from 70° C. to 360° C. inclusive; halides of hydrocarbons having 1 to 12 carbon atoms such as methyl chloride, methylene chloride, chloroform, and carbon tetrachloride; fluorine-containing compounds such as hydrofluoroether; silanes having an alkyl group having 1 to 5 carbon atoms such as tetra methylsilane, trimethylethylsilane, trimethylisopropylsilane, and trimethyl-n-propylsilane; and compounds that are thermally decomposed upon heating to generate gas such as azodicarbonamide, N,N′-dinitrosopentamethylenetetramine, and 4,4′-oxybis(benzenesulfonyl hydrazide).

The foaming agent may be formed of one compound or may be formed of a mixture of two or more compounds. The foaming agent may be a linear, branched, or alicyclic compound and is preferably an alicyclic compound.

The encapsulation ratio of the foaming agent in the foamable particles is defined as the weight percentage of the encapsulated foaming agent with respect to the weight of a foamable particle. No particular limitation is imposed on the encapsulation ratio of the foaming agent. The encapsulation ratio is preferably from 2% by weight to 50% by weight inclusive and more preferably from 10% by weight to 20% by weight inclusive based on the weight of a foamable particle.

No particular limitation is imposed on the expansion onset temperature of the foamable particles. The expansion onset temperature is preferably 70° C. or higher. The average particle diameter (D50) of the foamable particles is from 5 μm to 30 μm inclusive. The average particle diameter (D50) can be measured by laser diffraction/scattering-type grain size distribution measurement.

Examples of the first binder resin contained in the foaming layer include cellulose resins, vinyl resins, acrylic resins, and polyester, and polyester is particularly preferable. It is preferable that the glass transition temperature of the first binder resin is lower than the glass transition temperature of the first resin in the peeling layer.

From the viewpoint of the sharpness of fine lines in a uneven pattern after foaming, it is preferable that the first binder resin contained in the foaming layer has high glass transition temperature and that the ratio of the foaming agent in the foaming layer is low. For example, the glass transition temperature of the first binder resin is preferably from 40° C. to 80° C. inclusive, and the ratio of the foaming agent in the foaming layer is preferably about 2:8 to about 4:6. From the viewpoint of the ratio of increase in the thickness of the foaming layer, it is preferably that the first binder resin contained in the foaming layer has low glass transition temperature. For example, the glass transition temperature of the first binder resin is preferably from −20° C. to 20° C. inclusive. The first binder resin is determined according to the required shape of the uneven pattern.

The thickness of the foaming layers (the total thickness of the plurality of foaming layers) before expansion of the foamable particles is preferably from 5 μm to 50 μm inclusive. The thickness of the foaming layers (the total thickness of the plurality of foaming layers) after the expansion of the foamable particles is preferably from 250 μm to 600 μm inclusive.

### (Adhesive Layer)

To improve the adhesion between the transfer receiving body and the transfer layer T, the adhesive layer 4 is disposed on the foaming layer 3. Examples of the material of the adhesive layer include: cellulose derivatives such as ethyl cellulose and cellulose acetate butyrate; styrene copolymers such as polystyrene and poly(α-methylstyrene); acrylic resins such as polymethyl methacrylate, polyethyl methacrylate, and polyethyl acrylate; vinyl resins such as polyvinyl chloride, polyvinyl acetate, vinyl chloride-vinyl acetate copolymers, and polyvinyl butyral; polyester; nylon resins; epoxy resins; and polyurethane. It is preferable that the glass transition temperature of the first resin in the adhesive layer is higher than the glass transition temperature of the first binder resin in the foaming layer.

### (Back Layer)

No limitation is imposed on the material of the back layer 5, and examples thereof include: cellulose resins such as cellulose acetate butyrate and cellulose acetate propionate; vinyl resins such as polyvinyl butyral and polyvinyl acetal; acrylic resins such as polymethyl methacrylate, polyethyl acrylate, polyacrylamide, and acrylonitrile-styrene copolymers; and natural and synthetic resins such as polyamide resins, polyamide-imide, polyester, polyurethane, and silicone-modified and fluorine-modified urethanes. The back layer may contain only one of these resins or may contain two or more of them.

### (Receiving Layer)

The transfer-type receiving layer R shown in FIG. 7 includes a receiving layer and an adhesive layer stacked in this order from the substrate side. No particular limitation is imposed on the material of the receiving layer, and it is preferable to use a binder resin that is easily dyed with the sublimation dyes contained in the coloring material layer. Examples of such a binder resin include: polyolefins such as polypropylene; halogenated resins such as polyvinyl chloride and polyvinylidene chloride; vinyl resins such as polyvinyl acetate and polyacrylic esters; polyesters such as polyethylene terephthalate and polybutylene terephthalate; polystyrene; polyamide; ionomers; and cellulose resins. The receiving layer may contain only one of these binder resins or may contain two or more of them.

The thickness of the receiving layer is generally from 1.0 μm to 10 μm inclusive and preferably from 1.0 μm to 5.0 μm inclusive.

### (Protective Layer)

Examples of the binder resin included in the protective layer 8 include polyester, polyesterurethane resins, polycarbonate, acrylic resins, epoxy resins, acrylic urethane resins, resins obtained by modifying the above resins with silicone, and mixtures of these resins. The protective layer may contain an ultraviolet absorbing resin or an active ray-curable resin. The active ray means a ray that chemically reacts with the active ray-curable resin to facilitate polymerization and specifically means visible light, ultraviolet light, X-rays, electron beams, α rays, β rays, γ rays, etc. To improve the transferability of the protective layer, a peeling layer may be disposed between the substrate and the protective layer.

### EXAMPLES

The present disclosure will next be described more specifically by way of Examples. However, the present disclosure is not limited to these Examples.

### Examples 1 to 14 and Comparative Examples 1 and 2

### (Production of Thermal Transfer Sheet 1)

A PET film having a thickness of 5 μm was used as a substrate, and a coating solution for a back layer having a composition described below was applied to one surface of the substrate and dried to form a back layer having a thickness of 1 μm. A coating solution for a peeling layer having a composition described below was applied to the other surface of the substrate and dried to form a peeling layer having a thickness of 0.5 μm. Next, a coating solution 1 for a foaming layer having a composition described below was applied to the peeling layer and dried to form a foaming layer having a thickness of 30 μm. Then a coating solution 1 for an adhesive layer having a composition described below was applied to the foaming layer and dried to form an adhesive layer having a thickness of 2.5 μm, and a thermal transfer sheet 1 including the back layer, the substrate, the peeling layer, the foaming layer, and the adhesive layer stacked in this order was thereby obtained.

### <Coating Solution for Peeling Layer>

Acrylic Resin
19 Parts by mass
(DIANAL (registered trademark) BR-87, Mitsubishi Chemical Corporation, glass transition temperature: 106° C.)

Polyester
1 Part by mass
(VYLON (registered trademark) 200, TOYOBO CO., LTD.)

Methyl Ethyl Ketone
40 Parts by mass

Toluene
40 Parts by mass

### <Coating Solution for Back Layer>

Polyvinyl Acetal
36 Parts by mass
(S-LEC (registered trademark) KS-1, SEKISUI CHEMICAL Co., Ltd.)

Isocyanate Compound
25 Parts by mass
(BURNOCK (registered trademark) D750, DIC Corporation)

Fine Silicone Resin Particles
1 Part by mass
(Tospearl (registered trademark) 240, Momentive Performance Materials Japan LLC)

Zinc Stearyl Phosphate
10 Parts by mass
(LBT1830 purified, Sakai Chemical Industry Co., Ltd.)

Zinc Stearate
10 Parts by mass

(SZ-PF, Sakai Chemical Industry Co., Ltd.)

Polyethylene Wax
3 Parts by mass
(POLYWAX 3000, TOYO ADL CORPORATION)

Ethoxylated Alcohol-Modified Wax
7 Parts by mass
(UNITHOX 750, TOYO ADL CORPORATION)

Methyl Ethyl Ketone
200 parts by mass

Toluene
100 Parts by mass

### <Coating Solution 1 for Foaming Layer>

Foamable Particles A
5 Parts by mass
(MATSUMOTO MICROSPHERE (registered trademark) HF30D, Matsumoto Yushi-Seiyaku Co., Ltd., foaming temperature: 115° C., average particle diameter: 14 μm)

Polyester
5 Parts by mass
(VYLONAL (registered trademark) MD1930, TOYOBO CO., LTD., glass transition temperature: −10° C.)

Water
23 Parts by mass

### <Coating Solution 1 for Adhesive Layer>

Polyester
5 Parts by mass
(VYLONAL (registered trademark) MD1930, TOYOBO CO., LTD., glass transition temperature: −10° C.)

Water
15 Parts by mass

### (Production of Thermal Transfer Sheet 2)

A thermal transfer sheet 2 was produced using the same procedure as that for the thermal transfer sheet 1 except that the coating solution 1 for a foaming layer having the above-described composition was applied to the peeling layer and dried to form a foaming layer having a thickness of 40 μm.

### (Production of Thermal Transfer Sheet 3)

A thermal transfer sheet 3 was produced using the same procedure as that for the thermal transfer sheet 1 except that the coating solution 1 for a foaming layer having the above-described composition was applied to the peeling layer and dried to form a foaming layer having a thickness of 20 μm.

### (Production of Thermal Transfer Sheet 4)

A thermal transfer sheet 4 was produced using the same procedure as that for the thermal transfer sheet 1 except that a coating solution 2 for an adhesive layer having a composition described below was applied to the foaming layer and dried to form an adhesive layer having a thickness of 2.5 μm.

### <Coating Solution 2 for Adhesive Layer>

Modified Polyolefin
4 Parts by mass
(ARROWBASE (registered trademark) SA1200, UNITIKA Ltd., glass transition temperature: −30° C.)

IPA
6 Parts by mass

Water
6 Parts by mass

### (Production of Thermal Transfer Sheet 5)

A thermal transfer sheet 5 was produced using the same procedure as that for the thermal transfer sheet 4 except that a coating solution 2 for a foaming layer having a composition described below was applied to the peeling layer and dried to form a foaming layer having a thickness of 30 μm.

### <Coating Solution 2 for Foaming Layer>

Foamable Particles B
5 Parts by mass
(MATSUMOTO MICROSPHERE (registered trademark) FN80GSD, Matsumoto Yushi-Seiyaku Co., Ltd., foaming temperature: 115° C., average particle diameter: 13 μm)

Polyester
5 Parts by mass
(VYLONAL (registered trademark) MD1930, TOYOBO CO., LTD.)

Water
23 Parts by mass

### (Production of Thermal Transfer Sheet 6)

A thermal transfer sheet 6 was produced using the same procedure as that for the thermal transfer sheet 4 except that a coating solution 3 for a foaming layer having a composition described below was applied to the peeling layer and dried to form a foaming layer having a thickness of 30 μm.

### <Coating Solution 3 for Foaming Layer>

Foamable Particles C
5 Parts by mass
(MATSUMOTO MICROSPHERE (registered trademark) HF36D, Matsumoto Yushi-Seiyaku Co., Ltd., foaming temperature: 115° C., average particle diameter: 13 μm)

Polyester
5 Parts by mass
(VYLONAL (registered trademark) MD1930, TOYOBO CO., LTD.)

Water
23 Parts by mass

### (Production of Thermal Transfer Sheet 7)

A thermal transfer sheet 7 was produced using the same procedure as that for the thermal transfer sheet 4 except that a coating solution 4 for a foaming layer having a composition described below was applied to the peeling layer and dried to form a foaming layer having a thickness of 30 μm.

### <Coating Solution 4 for Foaming Layer>

Foamable Particles D
5 Parts by mass
(MATSUMOTO MICROSPHERE (registered trademark) HF48D, Matsumoto Yushi-Seiyaku Co., Ltd., foaming temperature: 130° C., average particle diameter: 12 μm)

Polyester
5 Parts by mass
(VYLONAL (registered trademark) MD1930, TOYOBO CO., LTD.)

Water
23 Parts by mass

### (Production of Thermal Transfer Sheet 8)

A thermal transfer sheet 8 was produced using the same procedure as that for the thermal transfer sheet 4 except that a coating solution 5 for a foaming layer having a composition described below was applied to the peeling layer and dried to form a foaming layer having a thickness of 30 μm.

### <Coating Solution 5 for Foaming Layer>

Foamable Particles E
5 Parts by mass
(MATSUMOTO MICROSPHERE (registered trademark) F36LVD, Matsumoto Yushi-Seiyaku Co., Ltd., foaming temperature: 115° C., average particle diameter: 16 μm)

Polyester
5 parts by mass
(VYLONAL (registered trademark) MD1930, TOYOBO CO., LTD.)

Water
23 Parts by mass

### (Production of Thermal Transfer Sheet 9)

A thermal transfer sheet 9 was produced using the same procedure as that for the thermal transfer sheet 1 except that a coating solution 3 for an adhesive layer having a composition described below was applied to the foaming layer and dried to form an adhesive layer having a thickness of 2.5 μm.

### <Coating Solution 3 for Adhesive Layer>

Polyester
5 Parts by mass
(Elite) (registered trademark) KA-1237, UNITIKA Ltd., glass transition temperature: 71° C.)

Water
15 Parts by mass

### (Production of Thermal Transfer Sheet 10)

A thermal transfer sheet 10 was produced using the same procedure as that for the thermal transfer sheet 1 except that the coating solution 1 for a foaming layer having the above-described composition was applied to the peeling layer and dried to form a foaming layer having a thickness of 60 μm.

### (Production of Printed Materials)

A coated paper sheet having a thickness of 225 μm was prepared as a transfer receiving body. The transfer receiving body and the adhesive layer of one of the thermal transfer sheets 1 to 9 produced above were disposed so as to face each other, and a thermal transfer printer described below was used to transfer and stack a plurality of transfer layers each including the peeling layer, the foaming layer, and the adhesive layer onto the transfer receiving body. The transfer pattern for each transfer layer was a square having a size of 10 mm×10 mm in plan view (x and y direction dimensions of 10 mm).

An image was formed on the transfer receiving body with the transfer layers transferred thereonto and heated using heat rollers (Lamipacker Meister 6 PD3226 manufactured by FUJiPLA) to expand the foamable particles in the foaming layers, and a printed material was thereby produced. The temperature setting of the heat rollers was 150° C., and the speed was 0.4 m/min. The type of thermal transfer sheet, the number of transferred transfer layers, and the image formation method are shown in Table 1. “Fusion” in the image formation method means that a thermo-fusible ink was used, and “Sublimation” means that a sublimation dye was used. “InTM” means that an intermediate transfer medium was used.

### <Thermal Transfer Printer>

Thermal head: F3589 (manufactured by Toshiba Hokuto Electronics Corporation)
Average resistance value of heating element: 5015 Ω
Printing voltage: 15 V (18 V only in Comparative Example 2)
Resolution in main scan direction: 300 dpi (dot per inch)
Resolution in sub-scanning direction: 300 dpi
Line speed: 6.0 msec/line
Printing start temperature: 35° C.
Pulse Duty ratio: 85%
Gradation value: 255/255 (Maximum energy gradation)

### <<Transferability Evaluation>>

The transfer layers transferred from the thermal transfer sheet to the transfer receiving body were visually observed, and the transferability of the transfer layers was evaluated according to the following evaluation criteria. The evaluation results are shown in Table 1.

### (Evaluation Criteria)

◯ No defective transfer (tailing and non-transferred portions).

Δ Defective transfer was less than 10%.

x Defective transfer was 10% or more.

### <<Evaluation of Foaming Amount>>

The thickness of the stacked transfer layers was measured before and after foaming (expansion), and the thickness before foaming was subtracted from the thickness after foaming to compute the amount of foaming. The amount of foaming was evaluated according to the following evaluation criteria. To measure the thickness, a digital micrometer (MDC-25MX, Mitutoyo Corporation) was used.

### (Evaluation Criteria)

⊚ 400 μm or more.

◯ 250 μm or more and less than 400 μm.

Δ 150 μm or more and less than 250 μm.

x Less than 150 μm.

<<Evaluation of Sharpness>>

The x and y direction dimensions of the transfer layers (foaming layers) after foaming were measured. For the larger one of the measured dimensions, the magnification with respect to the dimension before foaming was computed, and the sharpness of the pattern was evaluated according to the following evaluation criteria. To measure the dimensions of the transfer layers after foaming, a microscope (VHX1000, KEYENCE CORPORATION) was used.

### (Evaluation Criteria)

◯ Less than 125%.

Δ 125% or more and less than 155%.

x 155% or more.

TABLE 1

| | | | Number of | | | |
|---|---|---|---|---|---|---|
| | | Image | transferred | | | |
| | Type of | formation | transfer | | Foaming | |
| | thermal transfer sheet | method | layers | Transferability | amount | Sharpness |
| Example 1 | Thermal transfer sheet 1 | Fusion | 2 | ◯ | ◯ | ◯ |
| Example 2 | Thermal transfer sheet 1 | Fusion | 3 | ◯ | ◯ | ◯ |
| Example 3 | Thermal transfer sheet 1 | Fusion | 4 | ◯ | ⊚ | ◯ |
| Example 4 | Thermal transfer sheet 1 | Sublimation | 3 | ◯ | ◯ | ◯ |
| Example 5 | Thermal transfer sheet 1 | Fusion InTM | 3 | ◯ | ◯ | ◯ |
| Example 6 | Thermal transfer sheet 1 | Sublimation | 3 | ◯ | ◯ | ◯ |
| | | InTM | | | | |
| Example 7 | Thermal transfer sheet 2 | Fusion | 2 | ◯ | ◯ | ◯ |
| Example 8 | Thermal transfer sheet 3 | Fusion | 4 | ◯ | ◯ | ◯ |
| Example 9 | Thermal transfer sheet 4 | Fusion | 3 | ◯ | ◯ | ◯ |
| Example 10 | Thermal transfer sheet 5 | Fusion | 3 | ◯ | ◯ | ◯ |
| Example 11 | Thermal transfer sheet 6 | Fusion | 3 | ◯ | ◯ | ◯ |
| Example 12 | Thermal transfer sheet 7 | Fusion | 3 | ◯ | ◯ | ◯ |
| Example 13 | Thermal transfer sheet 8 | Fusion | 3 | ◯ | ◯ | ◯ |
| Example 14 | Thermal transfer sheet 9 | Fusion | 2 | ◯ | ◯ | ◯ |
| Comparative | Thermal transfer sheet 1 | Fusion | 1 | ◯ | Δ | ◯ |
| Example 1 | | | | | | |
| Comparative | Thermal transfer sheet 10 | Fusion | 1 | X | ◯ | X |
| Example 2 | | | | | | |

### Reference Examples 1 to 4

### (Production of Thermal Transfer Sheet 11)

A PET film having a thickness of 5 μm was used as a substrate, and the coating solution for a back layer having the above-described composition was applied to one surface of the substrate and dried to form a back layer having a thickness of 1 μm. The coating solution for a peeling layer having the above-described composition was applied to the other surface of the substrate and dried to form a peeling layer having a thickness of 1 μm. Next, a coating solution 6 for a foaming layer having a composition described below was applied to the peeling layer and dried to form a foaming layer having a thickness of 15 μm. Next, the coating solution 1 for an adhesive layer having the above-described composition was applied to the foaming layer and dried to form an adhesive layer having a thickness of 2 μm, and a thermal transfer sheet 11 including the back layer, the substrate, the peeling layer, the foaming layer, and the adhesive layer stacked in this order was thereby obtained.

### <Coating Solution 6 for Foaming Layer>

Foamable Particles F
5 Parts by mass
(MATSUMOTO MICROSPHERE (registered trademark) HF50D, Matsumoto Yushi-Seiyaku Co., Ltd., foaming temperature: 115° C., average particle diameter: 14 μm)

Polyester
5 Parts by mass
(VYLONAL (registered trademark) MD1930, TOYOBO CO., LTD., glass transition temperature: −10° C.)

Water
23 parts by mass

### (Production of Thermal Transfer Sheet 12)

A thermal transfer sheet 12 was produced using the same procedure as that for the thermal transfer sheet 11 except that, instead of the coating solution 6 for a foaming layer, a coating solution 7 for a foaming layer having a composition described below was applied to the peeling layer and dried to form a foaming layer having a thickness of 15 μm.

### <Coating Solution 7 for Foaming Layer>

Foamable Particles F
3 Parts by mass
(MATSUMOTO MICROSPHERE (registered trademark) HF50D, Matsumoto Yushi-Seiyaku Co., Ltd., foaming temperature: 115° C., average particle diameter: 14 μm)

Polyester
7 Parts by mass
(VYLONAL (registered trademark) MD1930, TOYOBO CO., LTD., glass transition temperature: −10° C.)

Water
23 parts by mass

### (Production of Thermal Transfer Sheet 13)

A thermal transfer sheet 13 was produced using the same procedure as that for the thermal transfer sheet 11 except that, instead of the coating solution 6 for a foaming layer, a coating solution 8 for a foaming layer having a composition described below was applied to the peeling layer and dried to form a foaming layer having a thickness of 15 μm.

### <Coating Solution 8 for Foaming Layer>

Foamable Particles F
7 Parts by mass
(MATSUMOTO MICROSPHERE (registered trademark) HF50D, Matsumoto Yushi-Seiyaku Co., Ltd., foaming temperature: 115° C., average particle diameter: 14 μm)

Polyester
3 Parts by mass
(VYLONAL (registered trademark) MD1930, TOYOBO CO., LTD., glass transition temperature: −10° C.)

Water
23 Parts by mass

### (Production of Thermal Transfer Sheet 14)

A thermal transfer sheet 14 was produced using the same procedure as that for the thermal transfer sheet 11 except that, instead of the coating solution 6 for a foaming layer, a coating solution 9 for a foaming layer having a composition described below was applied to the peeling layer and dried to form a foaming layer having a thickness of 15 μm.

### <Coating Solution 9 for Foaming Layer>

Foamable Particles F
5 Parts by mass
(MATSUMOTO MICROSPHERE (registered trademark) HF50D, Matsumoto Yushi-Seiyaku Co., Ltd., foaming temperature: 115° C., average particle diameter: 14 μm)

Polyester
5 parts by mass
(VYLONAL (registered trademark) MD1200, TOYOBO CO., LTD., glass transition temperature: 67° C.)

Water
23 parts by mass

### (Production of Printed Materials)

A PET film having a thickness of 100 μm was prepared as a transfer receiving body. The transfer receiving body and the adhesive layer of one of the thermal transfer sheets 11 to 14 produced above were disposed so as to face each other. The above-described thermal transfer printer was used to transfer and stack two transfer layers each including the peeling layer, the foaming layer, and the adhesive layer onto the transfer receiving body. The transfer pattern for each transfer layer was a square having a size of 10 mm×10 mm in plan view (x and y direction dimensions of 10 mm).

An image was formed on the transfer receiving body with the transfer layers transferred thereonto and heated using heat rollers (Lamipacker Meister 6 PD3226 manufactured by FUJiPLA) to expand the foamable particles in the foaming layers. In this manner, printed materials in Reference Examples 1 to 4 were produced. The temperature setting of the heat rollers was 150° C., and the speed was 0.4 m/min. The types of thermal transfer sheets used to produce the printed materials in Reference Examples 1 to 4 are shown in Table 2.

### <<Measurement of Amount of Foaming and Expansion Ratio>>

The thickness of each printed material was measured before and after foaming (expansion) of the foaming layer, and the thickness before foaming was subtracted from the thickness after foaming to compute the amount of foaming. The thickness of the transfer receiving body was subtracted from the thickness of the printed material to determine the thickness of the stacked transfer layers, and the thickness of the transfer layers after foaming was divided by the thickness of the transfer layers before foaming to compute the expansion ratio. The results of the computations are shown in Table 2. To measure the thickness of the printed material, a digital micrometer (MDC-25MX, Mitutoyo Corporation) was used.

### <<Measurement of Magnification in Plane Directions>>

The x and y direction dimensions of the transfer layers (foaming layers) after foaming were measured. For the larger one of the measured dimensions, the magnification with respect to the dimension before foaming was computed. The results of the computations are shown in Table 2. To measure the dimensions of the transfer layers after foaming, a microscope (VHX1000, KEYENCE CORPORATION) was used.

TABLE 2

| | | Ratio of | | | | | |
|---|---|---|---|---|---|---|---|
| | | foamable | Glass | | Foaming | | Magnification |
| | Type of | particles to | transition | | amount | Expansion | in plane |
| | thermal transfer sheet | binder resin | temperature | | (μm) | ratio | direction |
| Reference | Thermal transfer sheet 11 | 1:1 | −10° | C. | 123 | 4.2 | 1.5 |
| Example 1 | | | | | | | |
| Reference | Thermal transfer sheet 12 | 3:7 | −10° | C. | 116 | 4.3 | 1.2 |
| Example 2 | | | | | | | |
| Reference | Thermal transfer sheet 13 | 7:3 | −10° | C. | 140 | 4.7 | 1.5 |
| Example 3 | | | | | | | |
| Reference | Thermal transfer sheet 14 | 1:1 | 67° | C. | 95 | 3.4 | 1.2 |
| Example 4 | | | | | | | |

Although the present invention has been described in detail with reference to particular embodiments, it will be apparent to those skilled in the art that various modifications may be made therein without departing from the spirit and scope of the present invention.

The present application is based on Japanese Patent Application No. 2021-5867 filed on Jan. 18, 2021, which are incorporated herein by reference in its entirety.

### REFERENCE SIGNS LIST

1 substrate
2 peeling layer
3 foaming layer
4 adhesive layer
5 back layer
6 transfer receiving body
10 thermal transfer sheet

1. comprising:
a step of preparing a thermal transfer sheet including a substrate and a transfer layer that is disposed on one surface side of the substrate and includes a layer containing foamable particles; and
a step of heating the thermal transfer sheet to transfer the transfer layer of the thermal transfer sheet in a prescribed pattern a plurality of times onto a transfer receiving body to thereby form a layered body including a plurality of the transfer layers stacked one on another.

2. The method for manufacturing a printed material according to claim 1, the method further comprising a step of heating the layered body to expand the layers containing the foamable particles.

3. The method for manufacturing a printed material according to claim 1, wherein the transfer layer is transferred from the thermal transfer sheet in a dot pattern.

4. The method for manufacturing a printed material according to claim 3, wherein the layered body is heated to expand the layers containing the foamable particles to thereby join the layers containing the foamable particles together in adjacent dot-shaped portions of the transfer layers.

5. The method for manufacturing a printed material according to claim 1, wherein the transfer layer includes a peeling layer, the layer containing the foamable particles, and an adhesive layer that are stacked in this order on the one surface side of the substrate.

6. The method for manufacturing a printed material according to claim 5, wherein the glass transition temperature of a first resin in the peeling layer is higher than the glass transition temperature of a first binder resin in the foaming layer.

7. The method for manufacturing a printed material according to claim 5, wherein the glass transition temperature of a first resin in the adhesive layer is higher than the glass transition temperature of a first binder resin in the foaming layer.

8. A printed material comprising:
a transfer receiving body; and
a layered body disposed on the transfer receiving body and including a plurality of transfer layers stacked one on another,
wherein each of the plurality of transfer layers includes an adhesive layer and a layer containing foamable particles that are stacked in this order from a side toward the transfer receiving body.

9. The printed material according to claim 8, wherein each of the plurality of transfer layers further includes a peeling layer that is disposed on an opposite side from the transfer receiving body with respect to the layer containing the foamable particles.

10. A thermal transfer sheet comprising:
a substrate; and
a plurality of transfer layers disposed on one surface of the substrate in a frame sequential manner,
wherein each of the plurality of transfer layers includes a layer containing foamable particles and an adhesive layer that are stacked in this order on one surface side of the substrate.

11. A method for manufacturing a printed material, the method comprising:
a step of preparing a first thermal transfer sheet including a first substrate and a transfer layer that is disposed on one surface side of the first substrate and includes a layer containing foamable particles;
a step of preparing a second thermal transfer sheet including a second substrate and a coloring material layer disposed on one surface side of the second substrate;
a step of preparing a third thermal transfer sheet including a third substrate and a receiving layer disposed on one surface side of the third substrate;
a step of heating the first thermal transfer sheet to transfer the transfer layer of the first thermal transfer sheet in a prescribed pattern a plurality of times onto a transfer receiving body to thereby form a layered body including a plurality of the transfer layers stacked one on another;
a step of heating the second thermal transfer sheet to transfer a coloring material onto the receiving layer of the third thermal transfer sheet to thereby form an image; and
a step of heating the third thermal transfer sheet to transfer the receiving layer with the image formed thereon onto the layered body.

12. A method for manufacturing a printed material, the method comprising:
a step of preparing a first thermal transfer sheet including a first substrate and a transfer layer that is disposed on one surface side of the first substrate and includes a layer containing foamable particles;
a step of preparing a second thermal transfer sheet including a second substrate and a coloring material layer disposed on one surface side of the second substrate;
a step of preparing a third thermal transfer sheet including a third substrate and a receiving layer disposed on one surface side of the third substrate;
a step of heating the second thermal transfer sheet to transfer a coloring material onto the receiving layer of the third thermal transfer sheet to thereby form an image;
a step of heating the third thermal transfer sheet to transfer the receiving layer with the image formed thereon onto a transfer receiving body; and
a step of heating the first thermal transfer sheet to transfer the transfer layer of the first thermal transfer sheet in a prescribed pattern a plurality of times onto the transfer receiving body with the receiving layer transferred thereonto to thereby form a layered body including a plurality of the transfer layers stacked one on another.
